(19) United States
(12) Patent Application Publication
(10) Pub. No.: US 2012/0175095 A1
(43) Pub. Date: Jul. 12, 2012

(54) HEAT EXCHANGER MANIFOLD AND METHOD OF MANUFACTURE

(76) Inventors: Saade MAKHLOUF, Beirut (LB); Khalil EZZEDDINE, Beirut (LB)

(21) Appl. No.: 13/267,366

(22) Filed: Oct. 6, 2011

Related U.S. Application Data
(60) Provisional application No. 61/431,952, filed on Jan. 12, 2011.

(51) Int. Cl. F28F 9/02; B23P 15/26

(52) U.S. Cl. 165/173; 29/890.052

(57) ABSTRACT

This invention provides an efficient counter flow heat exchanger of various rectangular, cylindrical or spiral shapes, having two flow channels or more and four inlet/outlet or more. Wherein flow channels have a plurality of passageways created by interposing a roll formed metallic between metallic rectangular sheets to form the flow channel or chamber. Rectangular and roll formed sheets sealingly joined by linking means, preferably but not necessarily by continuous linear spot welding or argon welding process.

### CROSS REFERENCE TO RELATED APPLICATIONS

This application claims the benefit of U.S. Provisional Application No. 61/431,952, filed Jan. 12, 2011, the content of which is incorporated herein by reference thereto.

### COPYRIGHT & LEGAL NOTICE

A portion of the disclosure of this patent document contains material which is subject to copyright protection. The Applicant has no objection to the facsimile reproduction by anyone of the patent document or the patent disclosure as it appears in the Patent and Trademark Office patent file or records, but otherwise reserves all copyright rights whatsoever. Further, no references to third party patents or articles made herein is to be construed as an admission that the present invention is not entitled to antedate such material by virtue of prior invention.

### BACKGROUND OF THE INVENTION

This invention relates to heat exchangers and to a method of manufacturing a heat exchanger.

Heat exchangers are known in the art. A common industrial heat exchanger (sometimes used in air conditioning systems) is a spiral heat exchanger which uses a helical (coiled) tube configuration in which a pair of flat surfaces are coiled to form the two channels A and B which transport fluids and/or gases at different temperatures T1 (for the first liquid or gas) and T2 (for a second liquid or gas) in a counter flow arrangement, as shown in FIG. 1:

Each of the two channels has a long, curved path. The main advantage of a spiral heat exchanger as compared to in-line heat exchangers is its highly efficient use of space.

In such a prior art spiral heat exchanger, typically, the distance between the sheets that define the opposite surfaces of the spiral channels is maintained by using spacer studs that are welded prior to rolling of the sheets together.

Despite their relatively compact size, these spiral heat exchangers of the prior art are very inefficient, and generally only contain two channels, one for each fluid. The mentioned spacers do nothing more than maintain the distance between the major walls of each channel and can otherwise restrict fluid flow therein. The heat transfer surfaces are essentially these major walls and little more, in which the only means of increasing the heat transfer surfaces usually involves decreasing the distance between adjacent walls, which results in more windings which can restrict the flow rate of fluid through the heat exchanger as well as substantially add to the cost of manufacture.

Still further, prior art heat exchangers principally use traditional bead welding techniques in their manufacture. However, such welding may invoke mechanical stress and even cracking of the weld, particularly when there is a large difference in temperature between T1 and T2. Welded joints are even more likely to crack when the nature of metal used in the welding bead is different from the nature of metal used for the tubes or metallic sheets.

What is needed is a heat exchanger and method of manufacture thereof which overcomes these problems identified in the prior art

In particular, what is needed therefore is a heat exchanger channel configuration that increases the heat transfer efficiency between fluids, perhaps many fluids, while at the same time, remaining compact and relatively inexpensive to manufacture.

Still further, what is needed is a channel configuration that is applicable to the building of heat exchangers of any layout (spiral, cylindrical, square, etc.).

### SUMMARY OF THE INVENTION

This invention provides an efficient counter flow heat exchanger of various rectangular, cylindrical or spiral shapes, made up of at least one multi-channel manifold having two or more flow channels and four or more inlet/outlets, in which flow channels have a plurality of passageways created by interposing a roll formed, corrugated metallic sheet between metallic rectangular sheets to form the flow channel or chamber. Rectangular and roll formed sheets are sealingly joined in an economical manner preferably by continuous linear spot welding or argon welding process. Multiple channels of the invention are provided through the use of the multi-channel manifold made of rolled corrugated layers (i.e., a layer shaped in alternative ridges and grooves) which are welded or otherwise sealingly applied against the flat metallic sheets, thereby offering multiple channels through which two or more (even many more) fluids may pass to transfer or pickup heat, manufactured in an economical manner.

An object of the invention is to provide an improved method of manufacturing a high efficiency, high mechanical strength, compact and elegant metallic heat exchanger for various purposes which can be produced in an easily automated manner, insofar as the necessary operations are simple to carry out.

It is another object of the invention to minimize the loss of energy into the metallic sheet forming the heat exchanger.

It is another object of the invention to significantly increase the length of flowing channels without a considerable increase in heat exchanger size and weight.

In an advantage of the invention, an essentially unlimited “L” length of the heat transfer wall is made possible, which provides for a long time period of contact of the fluids with the heat transfer wall, as well as a large surface area of contact therewith (namely, by a first hot gas or liquid T1, and a second, cold gas or liquid T2).

In another advantage, a long “L” may be provided in a compact design as compared with prior art systems which means a relatively larger contact surface area and most important a longer contact time A long contact time and a long length in a compact design make it possible to recover essentially the totality (over 95%) of exhaust heat.

In another advantage, the invention's design provides the ready ability to offer multiple T1 flowing channels

### BRIEF DESCRIPTION OF THE DRAWINGS

FIG. 1 shows a spiral heat exchanger of the prior art, in schematic representation.

FIG. 2 is a cross section through a preferred embodiment of a multi-channel manifold of the invention, formed as a spiral heat exchanger.

FIG. 3 is a view in perspective of a multi-channel manifold constituted by two roll formed metallic sheets and two rectangular sheets spirally wound to form a cylindrical void and by four inlet/outlet admissions of the heat exchanger according to the invention.

FIG. 4 is a schematic view in perspective showing the first phase of the winding of a multi-channel manifold of a spiral heat exchanger formed with two roll formed sheets and two rectangular sheets.

FIG. 5 shows another embodiment of a multi-channel manifold of a spiral heat exchanger of the invention created with one rectangular sheet and one roll formed sheet, wherein the plurality of passageways are used to form two different counter flow channels.

FIG. 6 is a cross-sectional horizontal view of a spiral heat exchanger made of the multi-channel manifold as shown in FIGS. 1 and 2

FIG. 7 is a schematic view in perspective showing a rectangular heat exchanger made of the multi-channel manifold of the invention.

FIGS. 8A-8D are sectional views of different shapes of multi-channel manifolds formed of various roll formed sheets.

FIG. 9 is a schematic diagram showing efficiency loss in a heat exchanger.

FIG. 10 is a flow chart of a method of manufacture of the invention.

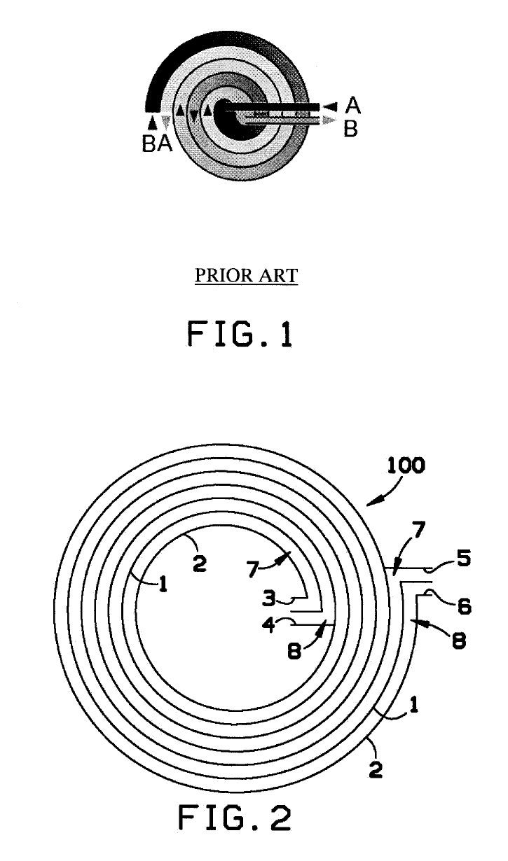

Those skilled in the art will appreciate that elements in the Figures are illustrated for simplicity and clarity and have not necessarily been drawn to scale. For example, dimensions may be exaggerated relative to other elements to help improve understanding of the invention and its embodiments. Furthermore, when the terms ‘first’, ‘second’, and the like are used herein, their use is intended for distinguishing between similar elements and not necessarily for describing a sequential or chronological order. Moreover, relative terms like ‘front’, ‘back’, ‘top’ and ‘bottom’, and the like in the Description and/or in the claims are not necessarily used for describing exclusive relative position. Those skilled in the art will therefore understand that such terms may be interchangeable with other terms, and that the embodiments described herein are capable of operating in other orientations than those explicitly illustrated or otherwise described.

### DETAILED DESCRIPTION OF THE PREFERRED EMBODIMENT(S)

Generally, the present invention relates to a multi-channel manifold and a high efficiency heat exchanger made from such multi-channel manifold and to a method of forming the multi-channel manifold.

This invention provides an efficient counter flow heat exchanger of various rectangular, cylindrical or spiral shapes. This heat exchanger is made up of, at least one multi-channel manifold, having two or more flow channels and four or more inlet/outlet in which flow channels have a plurality of passageways created by interposing a roll formed metallic sheet between metallic rectangular sheets.

According to one preferred aspect of the invention, the spiral heat exchanger of the invention has a multi-channel manifold including several flow channels or passageways created by spirally wound rectangular sheets, wherein the overlapping spiral layers that are formed by winding the rectangular sheets, are spaced apart by roll formed metallic sheets interposed between the spirally wound rectangular sheets, thereby maintaining even (i.e., constant) spacing between the spiral rectangular sheets and forming a plurality of spiral passageways which enable simple and efficient cleaning of the spiral channels. The flow channels may be thermally insulated by means of a thermal insulating material (i.e. mica sheet) which is laid on the manifold and rolled up with it, thus disposing the insulator between manifold windings. The Heat exchanger may of course be manufactured without insulating each winding of flow channels; however the insulator generally raises efficiency. So although this will slightly increase the weight of the heat exchanger, it generally increases its efficiency by about 5%. Without this mica sheet, the heat exchanger efficiency has not been shown to exceed 94%.

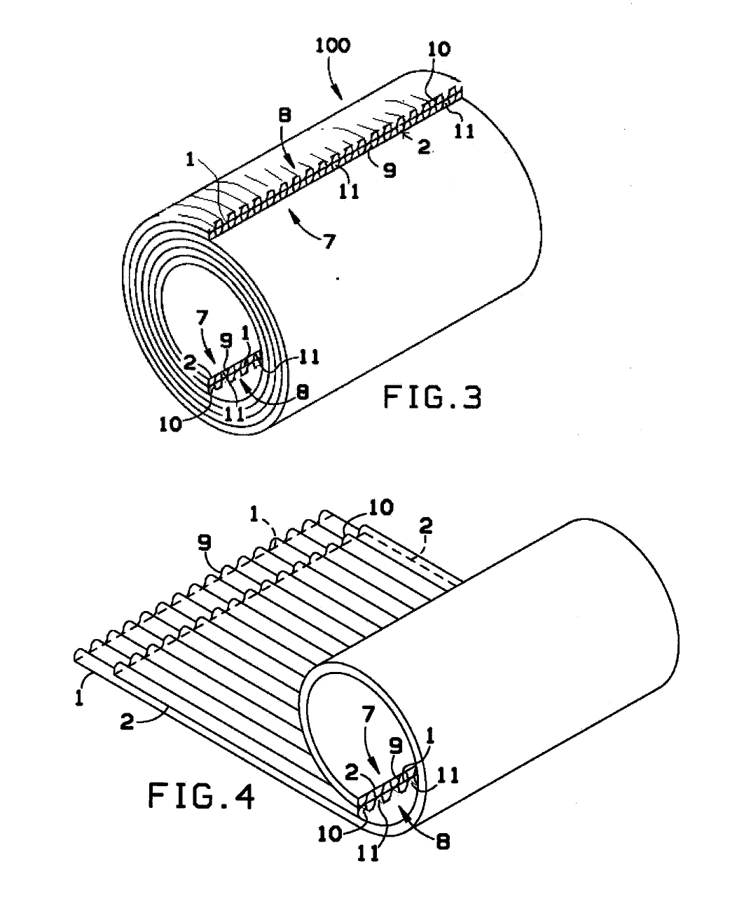

More specifically, referring to FIG. 2 there is illustrated a section through a multi-channel manifold 100 according to one preferred aspect of the present invention. The multi-channel manifold 100 includes two roll formed metallic sheets or dividers (not shown in this figure) interposed between a first 1 and second 2 spirally wound rectangular metallic sheets to form two flow channels 7, 8 and two Internal inlet/outlets 3, 4 within the inner central cylindrical void and two external inlet/outlets 5, 6 at the outer edge of the spiral.

Preferably as shown best in FIG. 3, a multi-channel manifold 100 of a counter flow spiral heat exchanger of the invention comprises two rectangular sheets 1, 2 spaced apart by two roll formed sheets 9, 10. Wherein the first roll formed sheet 9 is interposed between the rectangular sheets 1, 2 to form the first flow channel 7 with a plurality of passageways 11 and wherein the second roll formed sheet 10 is welded on the upper side of the second rectangular sheet in such a way that when the first flow channel 7 is wound, it forms the cylindrical void and the lower side of the first rectangular sheet 1 covers the rear end of the second roll formed sheet 10 to create the second flow channel 8. Thus, both flow channels share the same sheet as a separating heat transfer wall, in the embodiment in which two rectangular sheets and two corrugated sheets are used, for example. In this case, both rectangular sheets serve as a separating heat transfer wall between the two fluids, which is a significant advantage of the invention. These components may be welded using any means of welding such as continuous linear spot welding, laser welding, or argon welding. It should be noted that other welding processes may be applied, such as ultrasonic welding and, particularly, vacuum brazing. Although expensive, vacuum brazing provides a clean and strong weld. The roll formed metallic sheets or dividers 9, 10 are created by means of continuous forming operation (i.e. bending process) to create corrugations made up of multiple even channels. The roll formed sheets may be formed in a variety of configurations and shapes, for example, and without limitation, channels may be in the form of U, C, square, rectangular, elliptical, hat shapes or the like.

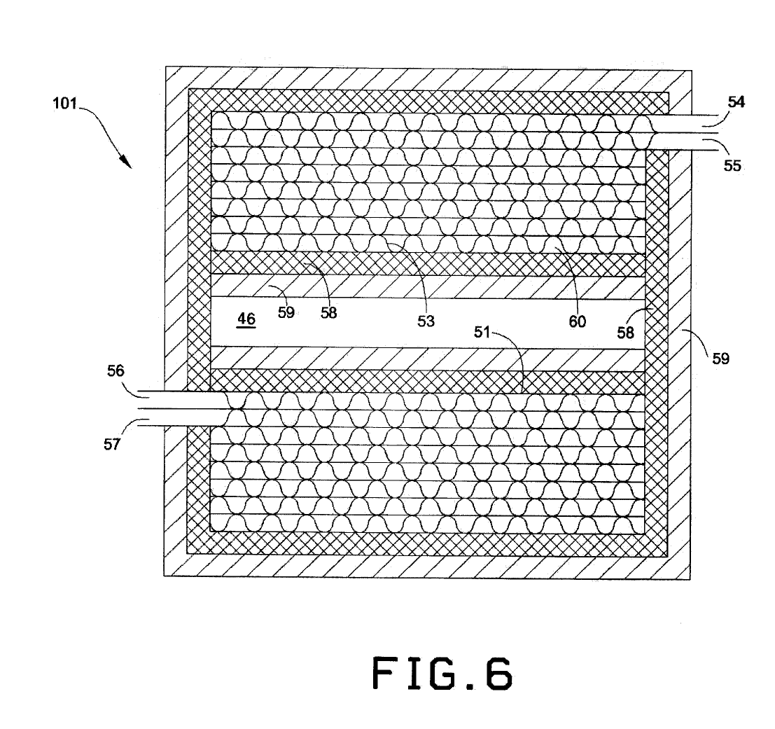

A thermal insulating material 59 (an analog of which is shown in FIG. 6), not shown in the drawings but well known in the art, encapsulates the external metallic casing 58, including the internal cylindrical void 46 (in the case of a spiral heat exchanger) to minimize heat loss. The external casing 58 helps the heat exchanger 100, 101 operate under very high pressure by raising its mechanical resistance to expansion of the manifold.

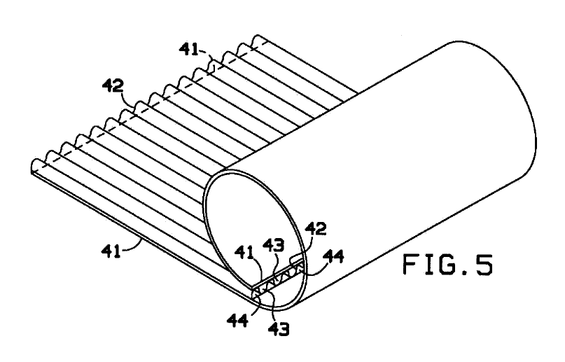

The winding of a spiral heat exchanger having two counter flow channels is shown in schematic FIG. 4, a plurality of passageways 11 created by two rectangular sheets 1, 2 wherein said rectangular sheets are spaced apart by a roll formed sheet 9 to form a first flow channel 7. The rear end of the first flow channel is wound in a counter clockwise direction to form a central cylindrical void and to cover the back side/rear end of the second roll formed sheet 10 to form a second flow channel 8 within the cylindrical void.

The invention has been illustrated herein generally by reference to a two fluid heat exchanger. However, it is not intended to be limited thereby. It is also contemplated that the inventive features are adapted for providing a heat exchanger for fluids in addition to two fluids. The dividers sheets 9, 10 form the flow channels, increase the contact area and provide a high mechanical strength.

Referring now to FIG. 5, the multi-channel manifold 100 of the invention is formed by one rectangular sheet 41 and one roll formed sheet 42. Wherein the roll formed sheet 42 and rectangular sheet 41 are joined by a linking mean preferably by continuous linear spot welding, the rear end of the rectangular sheet 41 is wound to form a central cylindrical void and to cover the upper side of the roll formed sheet to form a plurality of passageways 43 and 44 wherein each set of passageways form a flow channel. The length, height and width of flow channels may be varied appropriately as would be apparent to those of skill in the art.

Referring now to FIG. 6, the spiral heat exchanger shown in FIGS. 2 and 3 includes rectangular metallic sheets 51, 52 spaced apart by roll formed metallic sheet 53 to form flow channels with a plurality of passageways 60. The spiral heat exchanger 101 includes two internal inlet/outlets 54, 55 contained within the central cylindrical void and two external inlet/outlets 56, 57. The Heat exchanger 101 includes a thermal insulator 58 and an external casing/cover 589 which is encased by the insulator layer 59.

It should be emphasized that the invention is not limited to spiral heat exchangers. Heat exchangers of many different forms are possible. The inventor(s) have developed a rectangular heat exchanger in one of their industrial facilities whose efficiency enabled it to replace four large tubular heat exchangers while at the same time, being small in size.

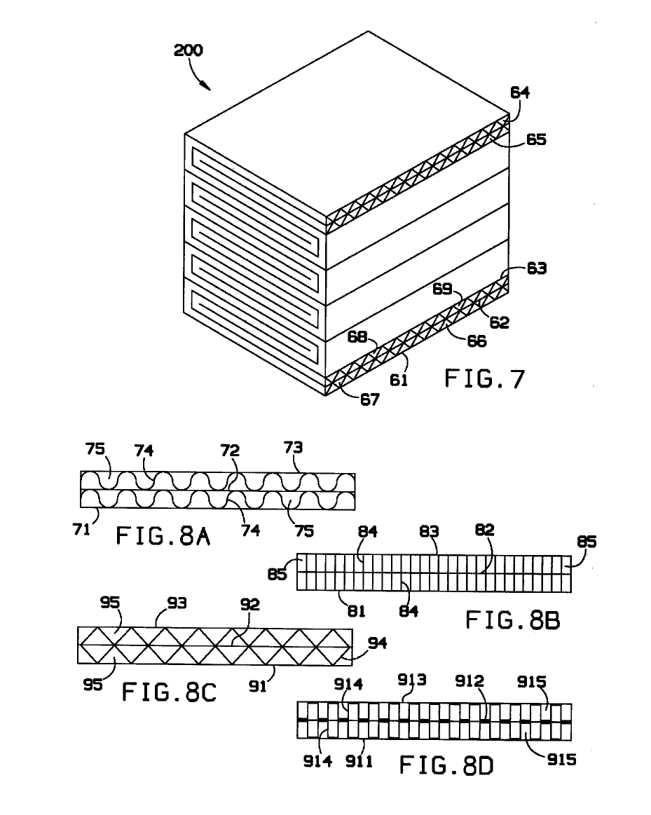

Referring now to FIG. 7, a rectangular heat exchanger manifold 200 of the invention includes rectangular sheets 61, 62, 63 spaced apart by roll formed metallic sheets 67, 68. The rectangular and roll formed sheets are sealingly joined by linking means to form flow channels 64, 65, 66, 69.

It should be noted that although the invention illustrated herein generally refers to a two fluid heat exchanger, it is not intended to be limited thereby. It is also contemplated that the inventive features are adapted for providing a heat exchanger for more than two fluids.

Referring now to FIGS. 8A-8D, schematic views of different shapes of roll formed sheets, FIG. 8A shows two roll formed sheets 74 interposed between rectangular sheets 71, 72, 73 to form two flow channel manifold having a plurality of passageways 75. These roll formed sheets have been roll formed to include a plurality of channel corrugations having a sinusoidal cross section.

Referring now to FIG. 8B, a different form of flow channels of the invention is made up of rectangular sheets 81, 82, 83 having ribs 84. The ribs 84 are made on the rectangular sheets, which are formed by stamping. The rectangular sheets are joined together to form flow channels with a plurality of passageways 85.

Referring now to FIG. 8C, another form of roll formed sheets 94 has a zigzag shape and is interposed between rectangular sheets 91, 92, 93 to form two flow channels having a plurality of passageways 95.

Referring now to FIG. 8D, two flow channels have a plurality of passageways 915 which have been created by interposing the roll formed sheets 914 having a U shape between rectangular sheets 911, 912, 913.

In addition to the apparatus itself, this invention provides an improved method of manufacturing a high efficiency, high mechanical strength, compact and elegant metallic heat exchanger for various purposes which can be produced in an easy automatized manner, insofar as the necessary operations are simple to carry out. The heat exchanger is constituted mainly by rectangular metallic sheets spaced apart by roll formed metallic sheets which have been roll formed by means of continuous forming operation (i.e. bending process) to create even U, C, hat shapes or the like.

This invention provides an efficient counter flow heat exchanger of various rectangular, cylindrical or spiral shapes, having two flow channels or more and four inlet/outlet or more. Wherein flow channels have a plurality of passageways created by interposing a roll formed metallic sheet between metallic rectangular sheets.

In general, a preferred embodiment is a spiral heat exchanger contemplates two rectangular sheets spaced apart by two roll formed sheets sealingly joined by linking means. Wherein the first roll formed sheet is interposed between the rectangular sheets to form the first flow channel with a plurality of passageways and wherein the second roll formed sheet is welded on the upper side of the second rectangular sheet in a way when the first flow channel is wound, it forms the cylindrical void and the lower side of the first rectangular sheet cover the rear end of the second roll formed sheet to create the second flow channel.

Use of the method of manufacturing of the invention is advantageous in the there is an unlimited flow channels length, very large surface area and very high axial and mechanical strength. The heat exchanger is then manufactured by automated continuous linear spot or argon welding and rolling process.

Easy to be manufactured in an automated manner (mass production) (automatic bending, rolling, forming and spot welding) that means it is economic. (for example, the heat exchanger used in tanks now cost over 700 thousand dollar because it cannot be manufactured in an automated manner)

The present invention particularly provides a counter flow heat exchanger with a very large contact surface area in a very compact design enabling to recover the totality of exhaust heat wherein the dividers sheets forming the flow channels, increase the contact area and provide a high mechanical strength. The high specific surface area allows for increased contact with the carrying medium. This leads to a more efficient system, in a smaller space. By the method according to the invention, the efficiency of the heat exchanger is considerably improved as compared with known heat exchangers. The metallic sheets may also be surface treated for locally varying the desired property and more specifically a surface roughening and corrugation process may be undertaken in order to increase the surface-area-to-volume ratio and to increase the effects of turbulences in the course of flow, so that the contact of the fluid against the wall is thus improved.

This heat exchanger is made of high melting point metal, preferably a high corrosion resistant metal such as stainless steel, monel alloy, Titanium, hest alloy or the like. It can be manufactured out of different types of metals, where it can be made out of hast alloy, nickel-chrome alloy, stainless steel alloy, titanium alloy so it can work at very high temperature and very high temperature delta (temperature difference between T1 and T2), such that it. (it does not crack under such a very high temperature delta between T1 and T2).)

In addition, significantly, because the heat exchanger of the invention is made out of metallic plates, this enables the application of surface etching processes such as by electro-chemical treatment, in order to increase the surface area of contact as compared to attempting the same with tubes used in some prior art solutions.

Depending upon the embodiment of the heat exchanger, various different shapes and configurations are contemplated for the heat exchanger. For example, the shape may also be rectangular, cylindrical or Spiral, for example. Although the spiral has a cylindrical shape, when one refers to a cylindrical heat exchanger, one generally means a heat exchanger which contains many cylinders one inside the other whereas a spiral heat exchanger is made by the winding of the metallic sheets The shapes and sizes of the heat exchanger may be varied as needed or desired for various embodiments of the heat exchanger.

The invention has been illustrated herein generally by reference to a two fluid heat exchanger. However, it is not intended to be limited thereby. It is also contemplated that the inventive features are adapted for providing a heat exchanger for fluids in addition to two fluids.

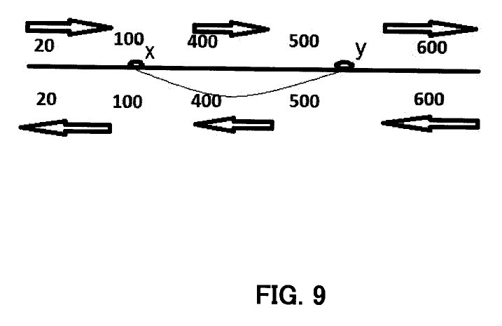

Referring now to FIG. 9, still further, the inventors have learned that there are sometime significant energy losses into the metallic sheet forming the heat exchanger. Why this occurs is not fully understood. Perhaps through the excitation of molecules in the metal and perhaps, though to a lesser extent, through heat conduction out the ends of the metal sheet.

The heat exchanger of the invention minimizes the loss of energy in the metallic sheet forming the heat exchanger. Referring again to FIG. 9, point x and point y along a single metallic sheet representing a counter flow heat exchanger is shown. Temperature gradients are shown for each fluid as they pass one another. Above, gradients 20, 100, 300, 500 and 600 are shown. Below, gradients 20, 100, 300, 500 and 600 are shown. The applicant has observed increasing efficiency losses between points x and y when the length of the metallic sheet decreases. The only means found to be highly effective by the applicant to minimize this inefficiency is to have a long manifold length or “L” dimension. The heat exchanger 100, 101, 200 of the invention allows for a high L in a very compact design and so helps overcome a drawback of prior art heat exchangers. Although prior art heat exchangers using thick metallic heat transfer sheets transfer heat better horizontally (across the thickness of the sheet), the heat exchanger 100, 101, 200 of the invention uses thin sheets and so the sheet thickness generally has little effect on the efficiency. Nevertheless, the thin metallic sheet transfers heat across it over its length (from point one to point two in the same sheet, from a hot point to the cold point). The efficiency of the heat exchanger 100, 101, 200 of the invention has been greatly improved where the sheet is long enough (and therefore the surface area of contact or heat transfer area large enough) to enable a complete recovery of heat.

This heat exchanger of the invention is different than all the prior art heat exchangers because of the following: it provides a long length “L” of channels in a very compact design. Long “L” means a long time of contact between T1 and T2. At the same time, its design provides a large contact surface area between T1 and T2. The invention also makes for a heat exchanger with a very high mechanical strength, thereby making it adaptable to high stress and dynamic situations because it can support minus and plus acceleration and vibration as well being able to operate under very high pressures (this is explained below). Further, the invention can also support a very high difference between T1 and T2. For example if T1 is 600 degrees Fahrenheit and T2 is 0 degrees Fahrenheit, the heat exchanger of the invention will not crack because of its novel structure and at the same time, where sufficient heat transfer area is designed into the specific heat transfer application, allows for essentially total recovery of energy even where the differences in temperatures T1 and T2 are extreme. Further, the spiral shape resists thermal expansion and so reduces the risk of thermal cracking.

In addition, the roll formed or corrugated sheet 9, 10 interposed between the rectangular sheets 1, 2 also raises the contact surface area without creating a resistance to the flow of fluid while at the same time creating a large surface area for heat transfer. In addition, the corrugations create turbulence in the fluid to further improve performance.

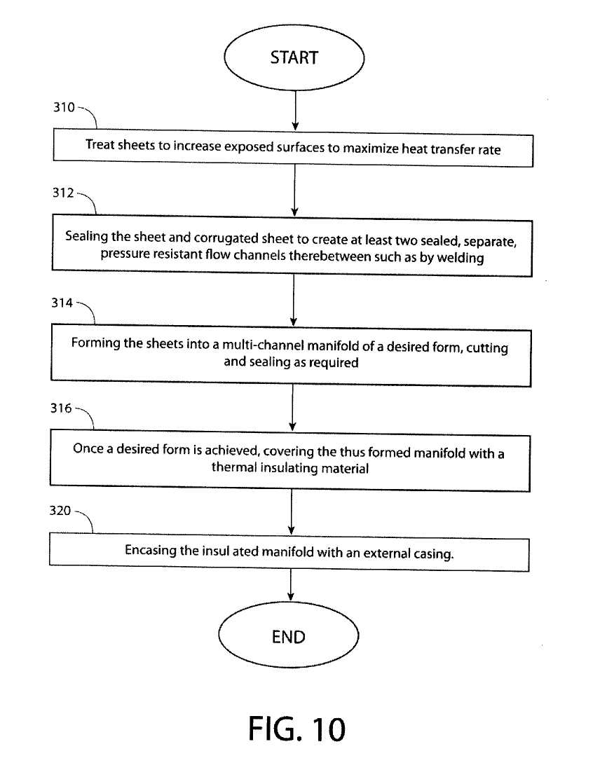

Referring now to FIG. 10, a method 300 of manufacturing the manifold 100 of the invention includes several steps. In a first step 310, at least one substantially rectangular, substantially flat, metallic sheet and at least one substantially rectangular corrugated, metallic sheet are treated using a surface treatment process selected from a group of processes consisting of electrodeposition, electrochemical etching or chemical etching in order to increase the contact surface area. Surface treatment is indeed very important because it increases the surface area tens of times and consequently raises the efficiency of the heat exchanger. Preferably, the surface treatment takes place in an automated or semi-automated fashion—In a second step 312, a sealing method automatically seals the at least one flat sheet and the at least one corrugated sheet together to create at least two sealed, separate, pressure resistant flow channels therebetween. The sheets are generally thinner than 2 mm (for a large heat exchanger used in power station for example, and less than 1 mm for cars) so they do not need to be heated to facilitate forming. The sealing method used is preferably welding using a process such as continuous linear spot welding, laser welding, ultrasonic welding, argon welding and vacuum brazing. Although vacuum brazing can be expensive, the process results in a strong weld. In a third step 314, the sheets are formed into a multi-channel manifold of a desired form, cutting and sealing as required. Where a spiral heat exchanger is to be formed, the manifold is wound into a spiral form. In a fourth step 316, once a desired form is achieved, the thus formed manifold is covered with a thermal insulating material. In a fifth step 320, the insulated manifold is encased with an external casing.

In general, a preferred embodiment is a spiral heat exchanger contemplates two rectangular sheets spaced apart by two roll formed sheets sealingly joined by linking means. Wherein the first roll formed sheet is interposed between the rectangular sheets to form the first flow channel with a plurality of passageways and wherein the second roll formed sheet is welded on the upper side of the second rectangular sheet in a way when the first flow channel is wound, it forms the cylindrical void and the lower side of the first rectangular sheet cover the rear end of the second roll formed sheet to create the second flow channel.

Use of the method of manufacturing of the invention is advantageous in the there is an unlimited flow channels length, very large surface area and very high axial and mechanical strength. The heat exchanger is then manufactured by automated continuous linear spot or argon welding and rolling process.

Easy to be manufactured in an automated manner (mass production) (automatic bending, rolling, forming and spot welding) that means it is economic. (for example, the heat exchanger used in tanks now cost over 700 thousand dollars because it cannot be manufactured in an automated manner)

The known prior art heat exchangers have not achieved a heat recovery rate over 30% in a single unit. In fact, it is common to use more than one heat exchanger to try to recover more energy. Prior art heat exchangers cannot be used in moving vehicles because of their low efficiency, heavy weight or large size as well as their inability to be manufactured in an economic automated manner. The ones that can be produced automatically are not efficient like this ideal heat exchanger.

The heat exchanger of the invention provides an “unlimited length” “L” in a compact design. Long “L” means also long contact period (time) between T1 and T2 making it possible to recover essentially the totality of energy from T1 even where the temperature difference between T1 and T2 (whether it is gas-gas, liquid-gas or liquid-liquid is large. A long length also means a larger contact surface area between T1 and T2.

Further, it should be noted that the external casing 59 which encases the heat exchanging core of the heat exchanger of the invention is assumed to be present in each embodiment as such is essentially necessary in order to enable the heat exchanger to withstand the sometimes very high fluid pressures involved.

Further, the invention may be easily adapted to a variety of applications by varying the spacing of flow channels and the number of windings or laps. Where used with an engine, such characteristics can be adapted to suit engine size and power.

Being compact means that there will be little loss of energy whereas prior art heat exchangers often require extensive insulation to avoid the loss of energy due to their large size.

Because it is compact, the amount of contact area of the heat exchanger of the invention which is in contact with the outside environment is small. Consequently, it can be easily insulated to avoid the loss of energy through the emission of infra-red radiation. Further, a spiral structure helps reduce the loss of energy through the emission of infra-red since each lap or winding of flowing channels reflects the heat of the other lap or windings.

Being compact also means that the heat exchanger of the invention can be used in cars. A prior art heat exchanger which sufficient capacity to remove and transfer heat might be larger than the car itself. Even the heat exchangers used in military tanks recover only about 22-25% maximum of exhaust heat. The same is true of heat exchangers used in gas turbines.

One advantageous feature of the present invention is the ability to easily integrate a plurality of different flow channels.

In an advantage, the invention provides a single solution that effectively decreases the consumption of oil and fuel in transport and energy production significantly (perhaps 40% or more).

In another advantage, because the heat exchanger of the invention is made out of metallic plates, this enables the surface treatment of metallic sheets (via, for example, electro-chemical treatment) to increase the surface area.

In another advantage, the invention works even when under very high pressure (from less than 1 bar to hundreds of bars). Even though the heat exchanger of the invention is compact, the design allows for reinforcement through increasing the thickness of the outer casing.

In another advantage, the heat exchanger of the invention provides a unique design facilitating the cleaning via high pressure/speed air current, high speed steam cleaning, or chemical cleaning (flash solution).

In another advantage, because the heat exchanger of the invention decreases the consumption of fuel, the use of the heat exchanger of the invention will have an immediate impact on the environment and the economy. Because the heat exchanger of the invention can be used in vehicles such as cars, bus, trains, boats, airplanes, as well as gas turbines in electricity production facilities, and different types of factories (heavy industries like ceramic, metals) etc . . . , the heat exchanger of the invention reduces the release of CO₂ three fold while at the same time, saving the world reserves of oil and it reduces the cost of production of goods and products.

In another advantage, because the heat exchanger of the invention is made out of metallic plates, this enables the surface treatment of metallic sheets (via, for example, electro-chemical treatment) to increase the surface area.

Another advantage is that the present invention provides an improved multi-fluid heat exchanger where additional flow channels can be easily added.

The length, height and width of flow channels may be varied appropriately as would be apparent to those of skill in the art. The thickness of the metallic sheets may be varied as would be apparent to those of skill in the art.

The heat exchanger may be installed in a variety of locations relative to article of manufacture to which the heat exchanger is applied.

The present invention also relates to a method of forming the heat exchanger. The heat exchanger may be a single fluid or multi-fluid (e.g., 2, 3 or 4 fluid) heat exchanger.

Although the heat exchanger according to the present invention may be used for a variety of articles of manufacture, the heat exchanger has been found particularly advantageous for use in automotive vehicles, gas and steam turbines, Diesel engines, Thermal Solar Energy, electrical power plants and different types of internal combustion engines especially because of its compact size and its very high efficiency where it recovers over 90% of the exhaust heat, consequently dramatically raising the efficiency of engines running on fossil fuel as well as gas and steam turbines. The present invention further excels in applications where space is confined, weight is restricted, and efficiency cannot be sacrificed.

Unless stated otherwise, dimensions and geometries of the various structures depicted herein are not intended to be restrictive of the invention, and other dimensions and geometries are possible. It will also be appreciated from the above that the fabrication of the unique structures herein and the operation thereof also constitute methods in accordance with the present invention.

Moreover, the system contemplates the use, sale and/or distribution of any goods, services or information having similar functionality described herein.

The specification and figures should be considered in an illustrative manner, rather than a restrictive one and all modifications described herein are intended to be included within the scope of the invention claimed. Accordingly, the scope of the invention should be determined by the appended claims (as they currently exist or as later amended or added, and their legal equivalents) rather than by merely the examples described above. Steps recited in any method or process claims, unless otherwise expressly stated, may be executed in any order and are not limited to the specific order presented in any claim. Further, the elements and/or components recited in apparatus claims may be assembled or otherwise functionally configured in a variety of permutations to produce substantially the same result as the present invention. Consequently, the invention should not be interpreted as being limited to the specific configuration recited in the claims.

Benefits, other advantages and solutions mentioned herein are not to be construed as critical, required or essential features or components of any or all the claims.

As used herein, the terms “comprises”, “comprising”, or variations thereof, are intended to refer to a non-exclusive listing of elements, such that any apparatus, process, method, article, or composition of the invention that comprises a list of elements, that does not include only those elements recited, but may also include other elements described in the instant specification. Unless otherwise explicitly stated, the use of the term “consisting” or “consisting of” or “consisting essentially of” is not intended to limit the scope of the invention to the enumerated elements named thereafter, unless otherwise indicated. Other combinations and/or modifications of the above-described elements, materials or structures used in the practice of the present invention may be varied or adapted by the skilled artisan to other designs without departing from the general principles of the invention.

The patents and articles mentioned above are hereby incorporated by reference herein, unless otherwise noted, to the extent that the same are not inconsistent with this disclosure.

Other characteristics and modes of execution of the invention are described in the appended claims.

Further, the invention should be considered as comprising all possible combinations of every feature described in the instant specification, appended claims, and/or drawing figures which may be considered new, inventive and industrially applicable.

Copyright may be owned by the Applicant(s) or their assignee and, with respect to express Licensees to third parties of the rights defined in one or more claims herein, no implied license is granted herein to use the invention as defined in the remaining claims. Further, vis-à-vis the public or third parties, no express or implied license is granted to prepare derivative works based on this patent specification, inclusive of the appendix hereto and any computer program comprised therein.

Multiple variations and modifications are possible in the embodiments of the invention described here. Although certain illustrative embodiments of the invention have been shown and described here, a wide range of changes, modifications, and substitutions is contemplated in the foregoing disclosure. While the above description contains many specific details, these should not be construed as limitations on the scope of the invention, but rather exemplify one or another preferred embodiment thereof. In some instances, some features of the present invention may be employed without a corresponding use of the other features. Accordingly, it is appropriate that the foregoing description be construed broadly and understood as being illustrative only, the spirit and scope of the invention being limited only by the claims which ultimately issue in this application.

What is claimed is:

1. A multi-channel manifold suitable for forming in any number of final shapes and adaptable for use in a heat exchanger, the multi-channel manifold comprising at least one essentially flat metal sheet sealingly joined to a corrugated metal sheet of comparable size in an orientation in which the sheet is essentially adjacent to the corrugated metal sheet such that the joined sheets form two or more fluid flow channels therebetween, each fluid flow channel having an associated inlet opening and outlet opening.

2. The manifold of claim 1, wherein the sheets are roll-formed.

3. The manifold of claim 1, wherein at least one surface of the sheets are etched to increase the exposed surface.

4. The manifold of claim 1, wherein the sheets are sealingly joined by a continuous linear spot welding or argon welding process.

5. The manifold of claim 1, wherein the sheets are sealingly joined using a laser welding process.

6. The manifold of claim 1, comprising a first and a second rectangular sheet and a first and a second corrugated sheet in which the first corrugated sheet is interposed between and sealingly attached to the first and second rectangular sheets and the second corrugated sheet is placed on and sealingly attached to an outer surface of a rectangular sheet with respect to the first corrugated sheet, and wherein the sheets are so sealed together as to form at least two sealed, separate, pressure resistant flow channels suitable for use in a heat exchanger.

7. The manifold of claim 1, wherein the final shapes of the heat exchanger made therefrom may be characterized as being a shape selected from a group of forms consisting of rectangular, cylindrical, elliptical, and spiral forms, and any combination thereof.

8. The manifold of claim 1, wherein an insulating layer is disposed between adjacent manifolds.

9. The manifold of claim 1, wherein the insulating layer is flexible.

10. The manifold of claim 9, wherein the insulating layer is made of mica.

11. A heat exchanger made using the manifold of claim 1.

12. The heat exchanger of claim 11, wherein the heat exchanger is enshrouded in a pressure chamber.

13. A method of manufacturing a multi-channel fluid flow manifold, wherein the method includes the steps of:
a. treating at least one substantially rectangular, substantially flat, metallic sheet and at least one substantially rectangular corrugated, metallic sheet using a surface treatment process selected from a group of processes consisting of electrodeposition, electrochemical etching or chemical etching in order to increase the contact surface area; (the surface treatment is very important because it increases the surface area tens of times and consequently raises the efficiency of the heat exchanger), optionally, in an automated fashion;
b. using a sealing method, automatically sealing the at least one flat sheet and the at least one corrugated sheet together to create at least two sealed, separate, pressure resistant flow channels therebetween;
c. forming the sheets into a multi-channel manifold of a desired form, cutting and sealing as required;
d. once a desired form is achieved, covering the thus formed manifold with a thermal insulating material; and
e. encasing the insulated manifold with an external casing.

14. The method of claim 13 wherein the sealing method is a welding.

15. The method of claim 14, wherein the welding process is selected from a group of welding processes consisting of continuous linear spot welding, laser welding, ultrasonic welding, argon welding and vacuum brazing.

16. The method of claim 14, wherein the forming is a rolling process, rolling the multi-channel manifold to form a spiral form.

17. A heat exchanger comprising a multi-channel fluid flow manifold made according to the method of claim 13.

18. A heat exchanger comprising a multi-channel fluid flow manifold made according to the method of claim 16.

19. A multi-channel manifold suitable for forming in any number of final shapes and adaptable for use in a heat exchanger, the multi-channel manifold comprising at least one essentially flat metal sheet sealingly joined using a continuous linear spot welding process to a corrugated metal sheet of comparable size in an orientation in which the sheet is essentially adjacent to the corrugated metal sheet such that the joined sheets form two or more fluid flow channels therebetween, each fluid flow channel having an associated inlet opening and outlet opening, wherein at least one surface of the sheets are etched to increase the exposed surface.

20. The manifold of claim 19, comprising a first and a second rectangular sheet and a first and a second corrugated sheet in which the first corrugated sheet is interposed between and sealingly attached to the first and second rectangular sheets and the second corrugated sheet is placed on and sealingly attached to an outer surface of a rectangular sheet with respect to the first corrugated sheet, and wherein the sheets are so sealed together as to form at least two sealed, separate, pressure resistant flow channels suitable for use in a heat exchanger.
